(19) United States
(12) Patent Application Publication
(10) Pub. No.: US 2006/0294021 A1
(43) Pub. Date: Dec. 28, 2006

(54) Accounting processing device

(75) Inventor: Takahiro Masuda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/268,452

(22) Filed: Nov. 8, 2005

(30) Foreign Application Priority Data
Jun. 28, 2005 (JP) 2005-187602

(51) Int. Cl. H04L 9/00

(52) U.S. Cl. 705/64

(57) ABSTRACT

To provide a technology enabling a proper accounting process by determining charge amounts for a plurality of contents on the basis of group information of the contents. A computer receives a content use request from a communication apparatus, searches out group information associated with the content from a storage unit stored with the group information showing a group of contents, and determines charge amounts of the plurality of contents on the basis of the content group information.

### BACKGROUND OF THE INVENTION

The invention relates to a technology for charging money corresponding to the use of a content such as music and a video.

A method of providing a user with a content (multimedia data) such as music, a video and a computer program via a network is exemplified by methods such as, when the user performs an operation for viewing and listening from on a terminal, providing data by streaming in real-time and downloading the multimedia data in a format enabling its reproduction on the user terminal (communication apparatus).

These types of contents can be also provided to a multiplicity of unspecified users and to only the users who have accounts by issuing the account to these specified users.

Further, in the case of thus providing the content by way of data, generally the content is charged money for distributing the data (content).

Moreover, the prior arts related to the invention of the application are, for instance, technologies disclosed in the following patent documents 1-6.

[Patent document 1] Japanese Patent Application Laid-Open Publication No. 2004-252848

[Patent document 2] Japanese Patent Application Laid-Open Publication No. 2001-144744

[Patent document 3] Japanese Patent Application Laid-Open Publication No. 2002-41993

[Patent document 4] Japanese Patent Application Laid-Open Publication No. 2002-352146

[Patent document 5] Japanese Patent Application Laid-Open Publication No. 2002-353957

[Patent document 6] Japanese Patent Application Laid-Open Publication No. 11-340966

### SUMMARY OF THE INVENTION

As described above, in the case of charging the money for distributing the content, the content copied without the provider's permission can not be charged money, and a problem is that if the copies are circulated by file sharing, a proper accounting process can not be executed.

Such being the case, it is considered that the content to be transmitted is encrypted, the user terminal acquires a decryption key from a server each time this content is reproduced, then the content is decrypted and thus reproduced, and the server charges money when acquiring the decryption key. With this scheme, even if the content is copied, the copied content can be surely charged money because of invariably accessing the server when reproducing the copied content.

As for the content such as music that has hitherto been put on the market in the form of a CD and a DVD, however, in the case of selling the content as a set of plural pieces of predetermined music such as an album and an omnibus as compared with selling a single, generally this type of content is sold at a low price for the number of pieces of music. On the other hand, if configured to charge money for every reproduction, in the case of reproducing the plural pieces of music, the amount of money is given by simply integrating the charge amounts for the respective pieces of music and is not relatively cheap unlike a general sales total, and this is not said to be proper accounting.

Further, if the music provided as a single is included in an album afterward, when this album is reproduced (replayed), it follows that the same music is dually charged money.

This being the case, the invention provides a technology enabling the proper accounting process by determining the charge amounts for the plurality of contents on the basis of group information of these contents.

The invention adopts the following configurations in order to solve the problems.

Namely, an accounting processing device of the invention comprises a request receiving unit receiving a content use request from a communication apparatus, a storage unit stored with group information showing a group of contents, and a charge amount determining unit determining charge amounts of the plurality of contents on the basis of the content group information.

The accounting processing device may further comprise a key transmission unit transmitting, when receiving the use request for the encrypted content, a decryption key for the content to the communication apparatus, wherein when transmitting the decryption key, the charge amount determining unit may determine the charge amount.

The charge amount determining means may, if the number of the use requests for the contents belonging to the same group exceeds a predetermined number, determine a charge amount to be lower than in the case of being equal to or smaller than the predetermined number.

Further, an accounting processing method of the invention is that a computer receives a content use request from a communication apparatus, searches out group information associated with the content from a storage unit stored with the group information showing a group of contents, and determines charge amounts of the plurality of contents on the basis of the content group information.

In the accounting processing method, when receiving the use request for the encrypted content, a decryption key for the content may be transmitted to the communication apparatus, and when transmitting the decryption key, the charge amount may be determined.

Moreover, in the accounting processing method, if the number of the use requests for the contents belonging to the same group exceeds a predetermined number, a charge amount may be determined to be lower than in the case of being equal to or smaller than the predetermined number.

Still further, a content distribution system of the invention includes a communication apparatus and a server that connected via a network, the server comprises a request receiving unit receiving a content use request from a communication apparatus, a storage unit stored with group information showing a group of contents, and a charge amount determining unit determining charge amounts of the plurality of contents on the basis of the content group information, and the communication apparatus comprises a use request unit transmitting a request for using a content to be reproduced to the server, and a reproducing unit reproducing the content.

Still further, the invention may also be an accounting processing program that makes a computer executes the accounting processing method. Yet further, the invention may also be a readable-by-computer recording medium recorded with this accounting processing program. The computer is made to read and execute the program on this recording medium, whereby the function thereof can be provided.

Herein, the recording medium readable by the computer connotes a recording medium capable of storing information such as data and programs electrically, magnetically, optically, mechanically or by chemical action, which can be read from the computer. Among these recording mediums, for example, a flexible disc, a magneto-optic disc, a CD-ROM, a CD-R/W, a DVD, a DAT, an 8 mm tape, a memory card, etc. are given as those demountable from the computer.

Further, a hard disc, a ROM (Read-Only Memory), etc. are given as the recording mediums fixed within the computer.

According to the invention, it is possible to provide a technology enabling a proper accounting process by determining charge amounts for a plurality of contents on the basis of group information of the contents.

### BRIEF DESCRIPTION OF THE DRAWINGS

FIG. 1 is a schematic view of a content distribution system of the invention.

FIG. 2 is an explanatory diagram of a content server of the invention.

FIG. 3 is an explanatory diagram of a communication apparatus.

FIG. 4 is a diagram showing an example of a content attribute database.

FIGS. 5A and 5B are diagrams showing an example of a reproduction start request and a reproduction end request.

FIG. 6 is a communication log when reproducing a content.

FIG. 7 is an explanatory diagram of an accounting processing method.

FIG. 8 is an explanatory diagram of a charge amount determining process.

FIG. 9 is a diagram showing an example of a log for determining a charge amount.

FIG. 10 is an explanatory diagram of the charge amount determining process.

### DETAILED DESCRIPTION OF THE PREFERRED EMBODIMENT

<Whole Configuration>

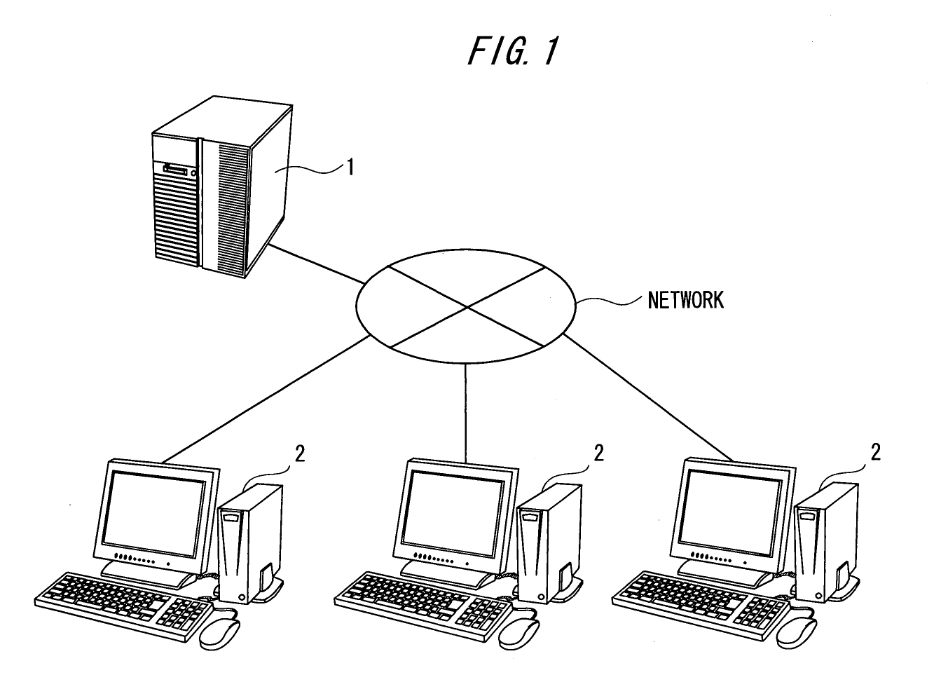

FIG. 1 is a schematic view of a content distribution system of the invention. The content distribution system in the embodiment is configured by a content server 1 and communication apparatuss 2 that are connected via a network such as the Internet.

The communication apparatus 2 is provided with data (contents) such as music, videos and computer programs in an encrypted state via the network like the Internet etc. or as (recorded) on a medium such as a CD-ROM and a DVD-ROM. When the communication apparatus 2 sends a content using request to the server 1, the server 1 transmits a decryption key for the content to the communication apparatus and executes an accounting process based on a log at that time.

<Explanations of Respective Components>

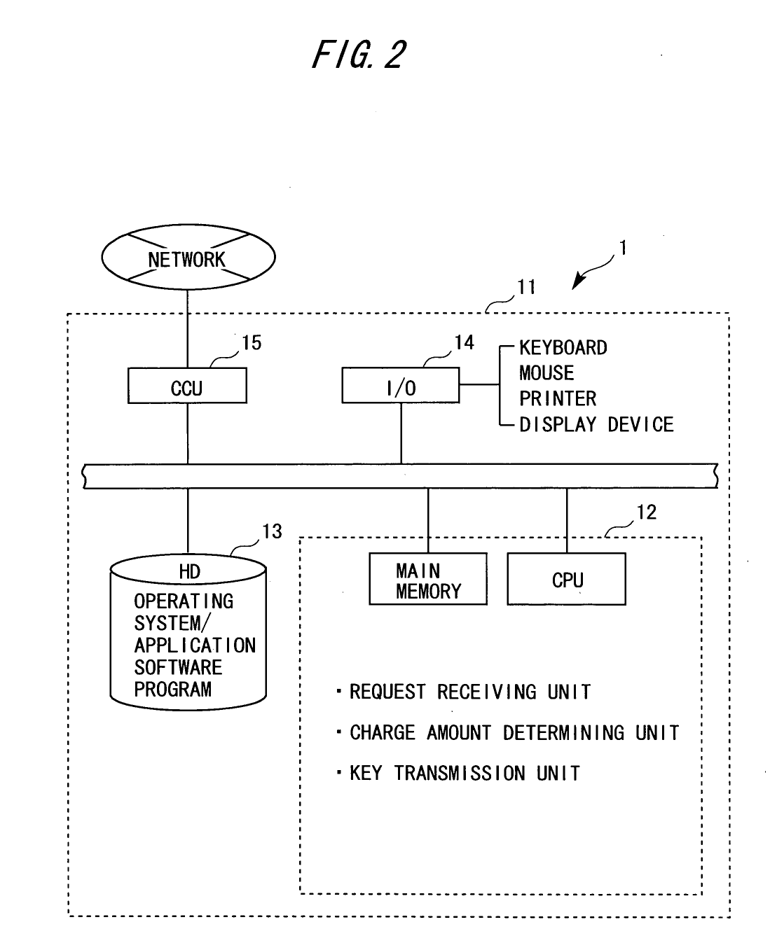

FIG. 2 is a schematic diagram of a configuration of the content server 1. As shown in FIG. 2, the content server 1 is a multi-purpose computer including an arithmetic processing unit 12, a storage unit (hard disc) 13, an input/output unit 14, a communication control unit 15, etc.

Input devices such as a keyboard, a mouse and a CD-ROM drive and output devices such as a display device and a printer, are properly connected to the I/O port 14.

The communication control unit 15 controls communications with other computers via the network.

The storage unit 13 is preinstalled with an operating system (OS) and application software (an accounting processing program, a compression archiver program, etc.). Further, the storage unit 13 is stored with contents, content attribute databases, communication logs with the communication apparatuss with respect to the contents, and accounting conditions for obtaining an amount of money charged (charge amount).

The arithmetic processing unit 12 is constructed of a CPU (Central Processing Unit), a main memory, etc., and functions also as a request receiving unit, a charge amount determining unit and a key transmission unit by properly reading the OS and the application software from the storage unit 13, executing the OS and the application software, and executing an arithmetic process upon information inputted from the I/O port 14 and from the communication control unit 15 and upon information read from the storage unit 13.

The request receiving unit receives the content using request.

The key transmission unit, in the case of receiving the content using request, transmits a decryption key for the content to the communication apparatus.

The charge amount determining unit determines an amount of money charged for the content of which the decryption key has been transmitted in accordance with a predetermined accounting condition by use of group information (album information) of the contents. For example, if a using request count of the content belonging to the same group exceeds a predetermined count, the charge amount determining unit determines a charge amount so that the charge amount becomes lower than in the case of being equal to or smaller than the predetermined count.

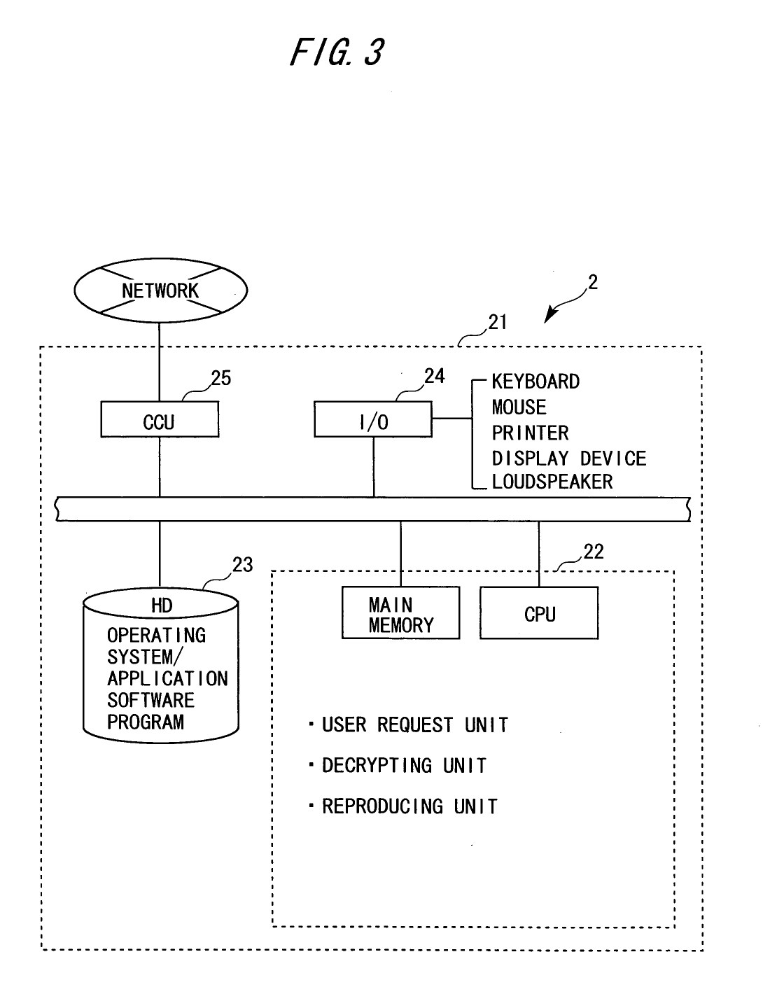

FIG. 3 is a schematic diagram of a configuration of the communication apparatus 2. As shown in FIG. 3, the communication apparatus 2 is a multi-purpose computer including an arithmetic processing unit 22, a storage unit (hard disc) 23, an input/output unit 24, a communication control unit 25, etc.

Input devices such as a keyboard, a mouse and a CD-ROM drive and output devices such as a display device and a loudspeaker, are properly connected to the I/O port 24.

The communication control unit 25 controls communications with other computers via the network.

The storage unit 23 is preinstalled with an operating system (OS) and application software (a content reproducing program etc.). Further, the storage 23 is stored with pre-acquired contents etc.

The arithmetic processing unit 22 is constructed of a CPU (Central Processing Unit), a main memory, etc., and functions also as a use requesting unit, a decryption unit and a reproducing unit by properly reading the OS and the application software from the storage unit 23, executing the OS and the application software, and executing an arithmetic process upon information inputted from the I/O port 24 and from the communication control unit 25 and upon information read from the storage unit 23.

The use requesting unit, when a content to be reproduced is designated by a user's operation, sends a content using request to the server 1.

The decryption unit, when receiving a decryption key for the content from the server 1, decrypts the content.

The reproducing unit reproduces the content and properly outputs a video and music to an output unit of the display device, the loudspeaker, etc.

<Encryption of Content>

The content employed in the invention is encrypted in steps S1 through S4 that follow.

S1) Music data, dynamic image data (that are not yet subjected to an encrypting process) are inputted as original multimedia data to the content server 1 from the I/O port 14.

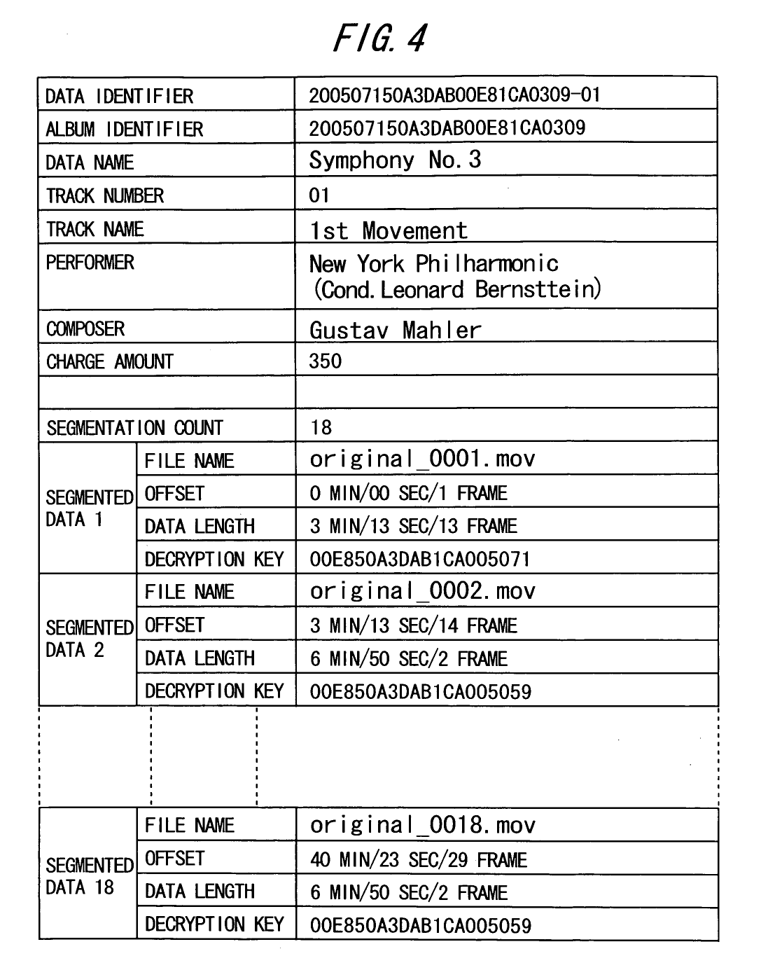

S2) The server 1 segments the multimedia data. For example, a condition such as [an interval of 30 sec for browsing time] or [a 100 kb-by-100 kb basis for a data size] is previously determined as a segmentation condition, and the original data is segmented according to this condition. At this time, the content attribute database is, as shown in FIG. 4, recorded with, as segmentation position information, pieces of information such as a segmentation count, a number (serial number) representing a segmentation sequence, an interval (offset) from a head of the original content to a head of each segmented file and a length of each segmented file (i.e., a data length, a frame count, time expended for reproduction, etc.) in order to specify which part of the pre-segmentation content each post-segmentation file corresponds to. Further, a file name of each segmented file is generated based on the segmentation position information. In the embodiment, if a file name of the original data is [original.mov], a serial number of each file is added to the file name “original” other than this extension, and names are given to make recognizable the segmenting sequence, i.e., the reproducing sequence such as [original 0001.mov], [original_{—}0002.mov]

S3) The server 1 encrypts the respective post-segmentation data files with keys different from each other, and records the keys (decryption keys) for decrypting the individual files on the content attribute database.

S4) The server 1 merges the thus-encrypted post-segmentation files into one data file by use of a compression archiver program. On this occasion, the segmentation position information showing how the content is segmented as carried out in step S2, is added.

As described above, the embodiment has exemplified the example in which the server 1 performs the encryption, however, without being limited to this example, there may be taken such a configuration that if the server 1 can be stored with the respective data files and the decryption keys in a way that associates these files with the encryption keys, another device executes the content segmenting process and the encrypting process, and the encryption key is obtained from this device and registered in the server 1.

Then, the data file, i.e., the content encrypted by the process given above is provided to the user via the network. Alternatively, this content is recorded on the medium such as the CR-ROM and thus provided to the user. Since this content can not be reproduced unless the content is decrypted by obtaining the plurality of decryption keys from the server 1, the data itself is not unlawfully used even if copied, and the content can be distributed beforehand to a multiplicity of unspecified users.

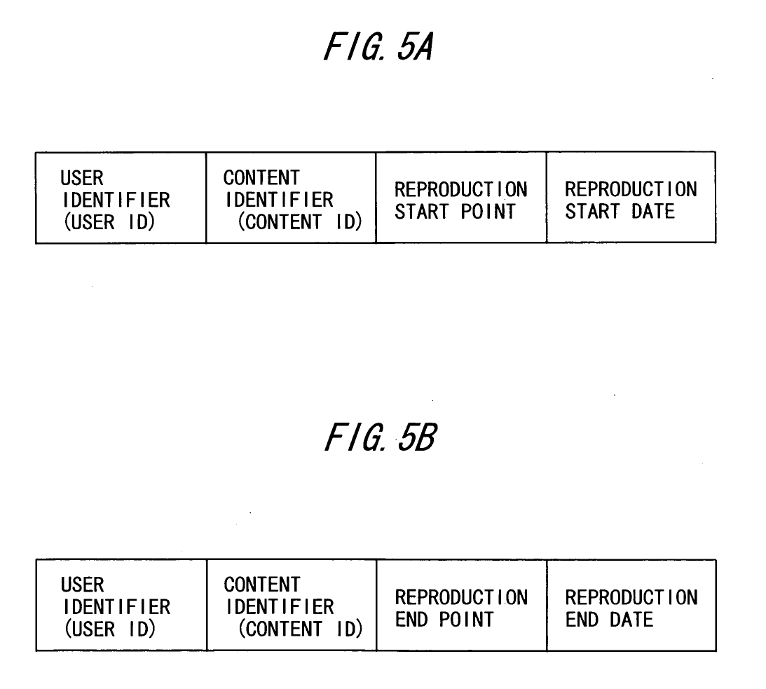

This communication apparatus 2 transmits, as shown in FIG. 5A, the following items of information A-D as a reproduction start request to a specified address, i.e., to the server 1 in this example.

A) An identifier (which will hereinafter be referred to as a content ID) for identifying a reproducing target content.

B) A reproduction start point ([from 2 min/13 sec/21 frame] etc.) indicating which part of the reproducing target content the reproduction starts from.

C) Date when the reproduction start is requested (reproduction start date).

D) An identifier for identifying the user (which will hereinafter be referred to as a user ID).

Further, the communication apparatus 2 transmits the following items of information E-H as a reproduction end request to a specified network address as shown in FIG. 5B.

E) A content ID for identifying the content of which the reproduction is finished.

F) A reproduction end point showing which part of the content the reproduction is ended with ([from 2 min/13 sec/21 frame] etc.).

G) Date when the reproduction is ended (reproduction end date).

H) A user ID of the user who requests the reproduction to be ended.

<Reproduction of Content>

On the occasion of reproducing the content, the communication apparatus 2 executes, for instance, steps S21-S28 that follows.

S21) When player software (a content reproducing program) is booted by the user's operation, the terminal 2 displays a content list on the display device, and prompts the user to select a should-be-reproduced content. At this time, there may be set a scheme by which the user can input the reproduction start point such as “from the beginning”, “from 21 min/13 sec/21 frame” and “from continuation of the last time”.

S22) When the content is selected and the reproduction is designated by the user's operation, the communication apparatus 2 reads the address of the server 1 from the storage unit 13, and connects to the server 1 via the network.

S23) The user ID is sent to the connected server 1. Note that the user shall previously execute a process of registration in the server 1 and shall be assigned a unique ID.

S24) The content ID, the segmented file and the segmentation position information are extracted from the selected content that should be reproduced.

S25) The reproduction start point is obtained based on the segmentation position information, and the reproduction start point and the content ID are sent as the reproduction start request to the server 1. Herein, the reproduction start point is obtained so as to become a head of the not-yet-reproduced files among the segmented files specified by the segmentation position information. Accordingly, in the content that is reproduced for the first time, to begin with, the head of the first segmented file is set as the reproduction start point, and next the head of the second segmented file is set as the reproduction start position, thus sequentially making the reproduction start request.

S26) In the case of receiving the decryption key matching with the reproduction start request from the server 1, the decryption unit decrypts the segmented file by use of the decryption key, and the reproducing unit reproduces this file.

S27) Then, before the reproduction is finished after starting the reproduction of the segmented file (for example, a timing anterior to the end time by a length of time given by adding a predetermined allowance to the time needed for acquiring one decryption key), returning to S25, the reproduction start request of the next segmented file is made, and the segmented file is decrypted, thus reproducing the segmented file without any interruption. With this scheme, the content is reproduced in a way that makes the user be unaware of the data being segmented.

S28) The communication apparatus 2 interrupts the reproduction if the decryption unit fails to decrypt.

S29) Further, if indicated to start reproducing a different content in the process of just reproducing, the request for finishing the content processed so far is temporarily made, and thereafter the reproduction start request for the new content is made.

Thus, the player in the embodiment reproduces (replays) the content while acquiring the decryption key, and therefore, if disconnected from the network in the process of reproducing, the data decrypted by the already-acquired decryption key are reproduced, however, the reproduction is discontinued because of being unable to acquire the decryption key after that. In this case, the communication apparatus 2 again connects to the server 1, and, unless a reproduction target content is designated, the reproducing process is not executed. Further, the content encrypted in the way described above can not be reproduced (replayed) by the general type of player that does not acquire the decryption key by accessing the server 1.

Hence, even if the content is copied among the users and thus spreads, the player invariably accesses the server 1 when in reproduction, and, at this access time, the player can be properly charged an amount of money (for reproducing) by executing the accounting process.

Moreover, a size of the key necessary for decrypting the content can be, as a matter of course, set smaller than a size of music data obtained after the decryption of the content, a small quantity of information flowing across the network when reproduced may suffice, and therefore a band can be effectively used.

<Decryption Key Providing Process by Server 1>

On the other hand, when the reproduction start request is given from the communication apparatus 2, the server 1 executes the following processes in S31 through S33.

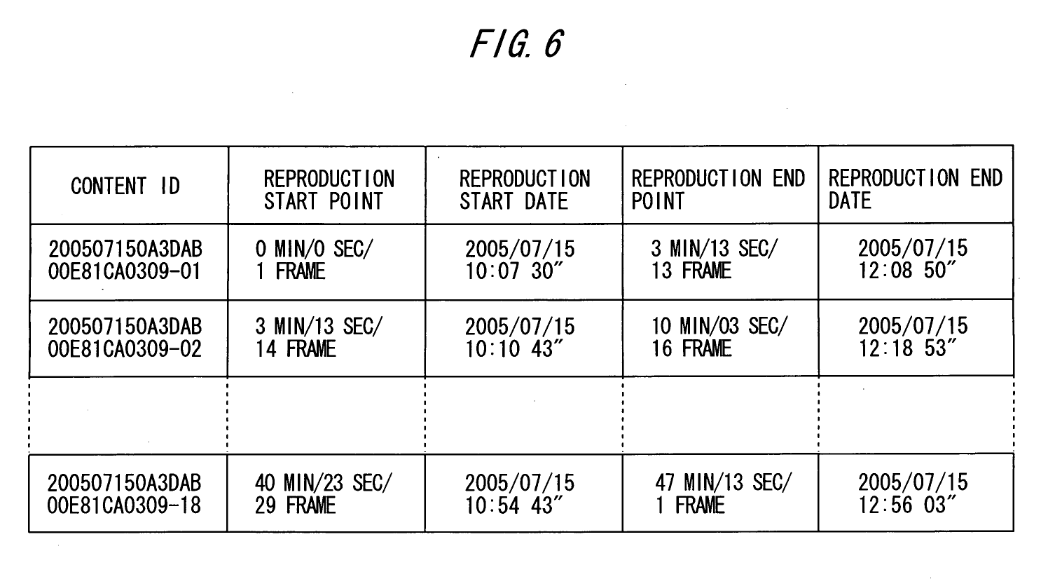

S31) In the case of receiving items of information A-D as a reproduction start request from the communication apparatus 2, the request receiving unit specifies the user based on the user ID (information D) in these items of information, and records the items of information A-C in a log file associated with the user as shown in FIG. 6.

S32) The key transmission unit reads a decryption key associated with a couple of the content ID and the reproduction start point (information A and B) from the content attribute database of the storage unit 13, and sends the decryption key to the communication apparatus 2. At this time, when receiving a specific value such as “2 min/13 sec/21 frame” as the reproduction start point, the server 1 refers to the segmentation position information and thus reads a decryption key for the segmented file that contains the reproduction start point. Moreover, when receiving the designation “from continuation of the last time” as the reproduction start point, the server 1 reads the decryption key for the segmented file that contains the reproduction end point recorded when ended last time.

S33) Furthermore, when receiving the reproduction start request for a next part (segmented file) of the content, i.e., when receiving the information showing the same content ID but a different reproduction start point, the server 1 repeats S31-S32, and sequentially transmits the decryption key for the associated segmented file to the communication apparatus 2.

S34) Then, when receiving items of information E-H as a reproduction end request from the communication apparatus 2, the server 1, as a finishing process, specifies the user based on the user ID (information H) in these items of information, and records the items of information E-G in a log file associated with the user as shown in FIG. 6.

It should be noted that when receiving the reproduction start request for the different content in the process of just reproducing the content, i.e., when receiving the reproduction request containing the same user ID but the different content ID before receiving the reproduction end request, the server 1 executes a process of providing the decryption key for a new content after executing the finishing process about the content processed so far. Further, if there is not made the reproduction start request for a next part for a predetermined period of time, the server 1 deems that a trouble (fault) occurs in the network connection or in the application, and executes the finishing process. The finishing process in this midway-of-reproduction case and in the case of making none of the reproduction start request for the next part, is such that a last part (delimiter) of the segmented file that can be decrypted by the decryption key transmitted last is set as the reproduction end point.

<Accounting Process by Server 1>

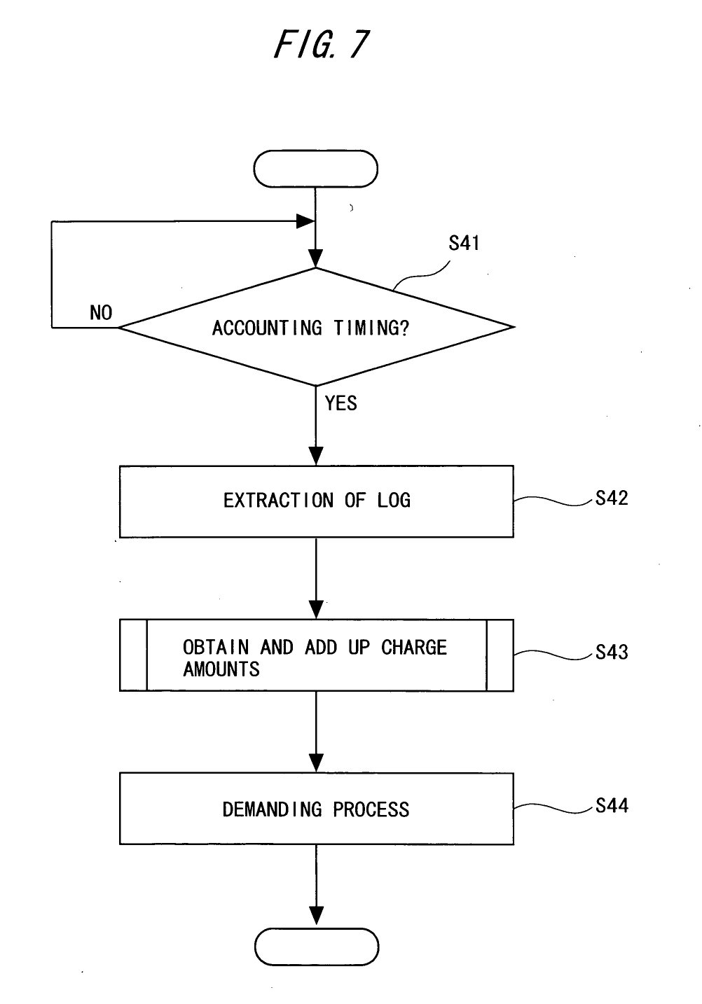

The server 1 executes the following accounting process as shown in FIG. 7 at a predetermined timing for performing the accounting such as the end of month, the beginning of month, the reproduction start request receiving time and the reproduction finishing process time.

S41) The server 1 detects whether the predetermined timing is reached or not.

S42) When the predetermined timing is reached, the accounting processing unit of the server 1 extracts a row (record) of the reproduced content from the log (FIG. 6) stored on the storage unit 13. For instance, the server 1 extracts the contents (events) subjected to the finishing process with respect to all the segmented files from the accounting timing of the last time up to the accounting timing of this time on the basis of the user ID, the segmentation count, the data number and the reproduction end date. Note that only the row of the last segmented file among the plurality of segmented files is extracted so that the extraction is made on a one-row-for-one content basis in this example.

S43) The charge amount determining unit obtains the charge amount per event on the basis of the extracted log in the way described above and adds up the charge amounts for every user.

S44) The server 1 executes a charge amount demanding process of charging each user on the basis of the totaled charge amount.

<Process of Obtaining Charge Amount Per Content>

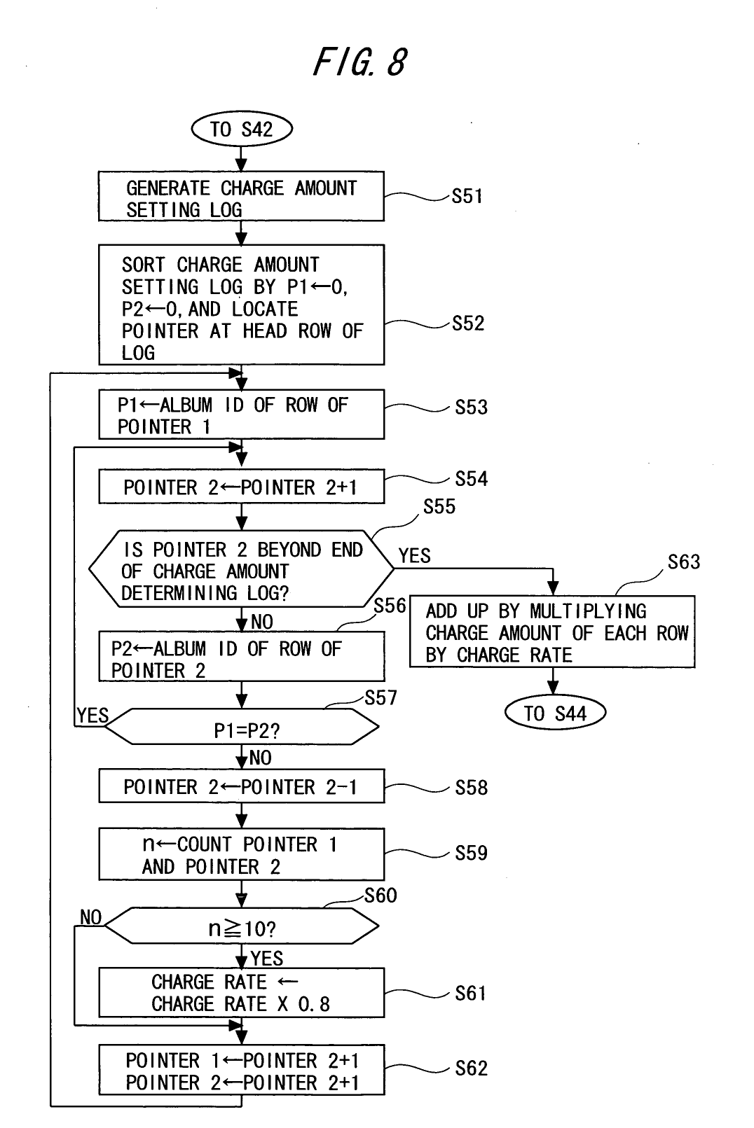

The process S43 for obtaining the charge amount will be explained with reference to FIG. 8. In FIG. 8, in the case of replaying (reproducing) a piece of music recorded on the same album, there is exemplified an example of demanding a charge amount with a discount.

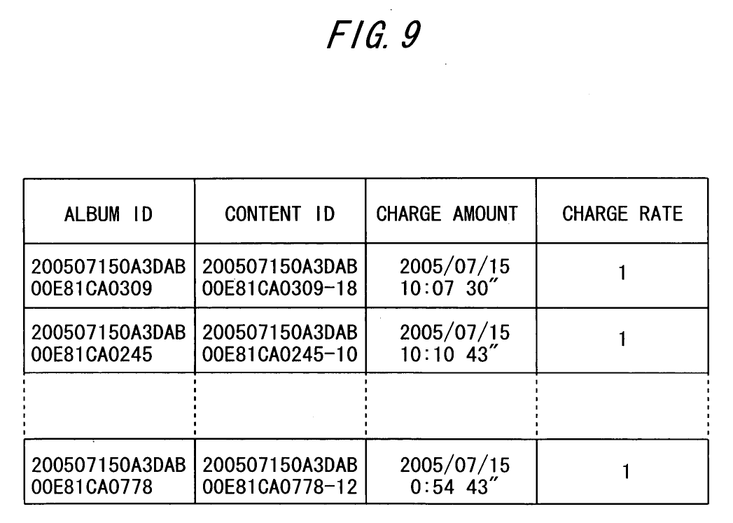

To begin with, the charge amount determining unit reads an album identifier associated with the data identifier and the charge amount from the attribute DB (database) with respect to each event of the log that is extracted in S42, and adds a column (field) of a charge rate in which column, for example “1” is assigned (entered) as an initial value, thus generating a charge amount determining log as shown in FIG. 9 (step 51 that is also abbreviated to S51). Further, by way of initial setting, the respective events in the log are sorted in an ascending sequence or a descending sequence according to the album identifier, wherein a pointer 1 and a pointer 2 that point the position of the processing target event are located in the foremost row. Further, values of each of variables P1, P2 is set to “0” (S52).

Next, the charge amount determining unit substitutes the album identifier of the row where the pointer 1 is located into the variable P1 (S53), and moves the pointer 2 to the next row (S54). Herein, it is judged whether the pointer 2 is beyond the last row or not (S55), and, if not beyond the last row, the album identifier of the row where the pointer 2 is located is substituted into the variable P2 (S56).

Then, the charge amount determining unit judges whether the variable P1 is the same as the variable P2 (S57) and, if coincident, returns to S54. Further, whereas if the variable P1 and the variable P2 are different from each other, the pointer 2 is moved back to the row one before (S58), and the charge amount determining unit counts how many rows exist from the pointer 2 to the pointer 1 including the row where the pointer concerned is located, i.e., counts the number of contents designated in the same album (S59).

The charge amount determining unit judges whether this row count reaches a reference value for becoming a discount target (S60) and, if equal to or higher than the reference value (which is 10 in the case of the example of this time), multiplies a discount rate (which is 0.8 in the case of the example of this time) corresponding to that row count by a charge rate of each of the events from the pointer 2 to the pointer 1 (S61). After this step 61, or after judging in step 60 that the row count is less than the reference value, the pointer 1 and the pointer 2 are moved to the row next to the pointer 2, and, returning to step 53, the same processes are repeated (S62).

Then, when judging in step 55 that the pointer 2 is beyond the last row in the log, the charge amount determining unit, after multiplying the charge amount for each row by the charge rate, adds up the charge amounts for all rows (S63).

Note that the reference value and the discount rate can be set to arbitrary values without being limited to the values given above. Further, a plurality of reference values and a plurality of discount rates may also be set. For example, if the number of contents (the number of rows) designated in the same album is equal to or larger than the reference value “10”, the discount rate may be set to 0.5, if less than the reference value “10” but equal to or larger than a reference value “7”, the discount rate may be set to 0.7, and, if less than the reference value “7” but equal to or larger than a reference value “5”, the discount rate may be set to 0.9.

Moreover, a rate to the number of contents designated in the album may also be set as a reference value. For instance, if the row count (the number of rows) for the number of contents structuring the album is equal to or larger than a reference value “½”, the discount rate is set to 0.5, and if less than the reference value “½” but equal to or larger than a reference value “⅓”, the discount rate is set to 0.7.

Further, a period for counting the number of contents in the same album may be differentiated from a period for adding up the charge amounts. For instance, the logs over the past one year are extracted irrespective of the accounting timing of the last time in S42, and the charge amounts for one month from the accounting timing of the last time up to the accounting timing of this time may also be added up in S58.

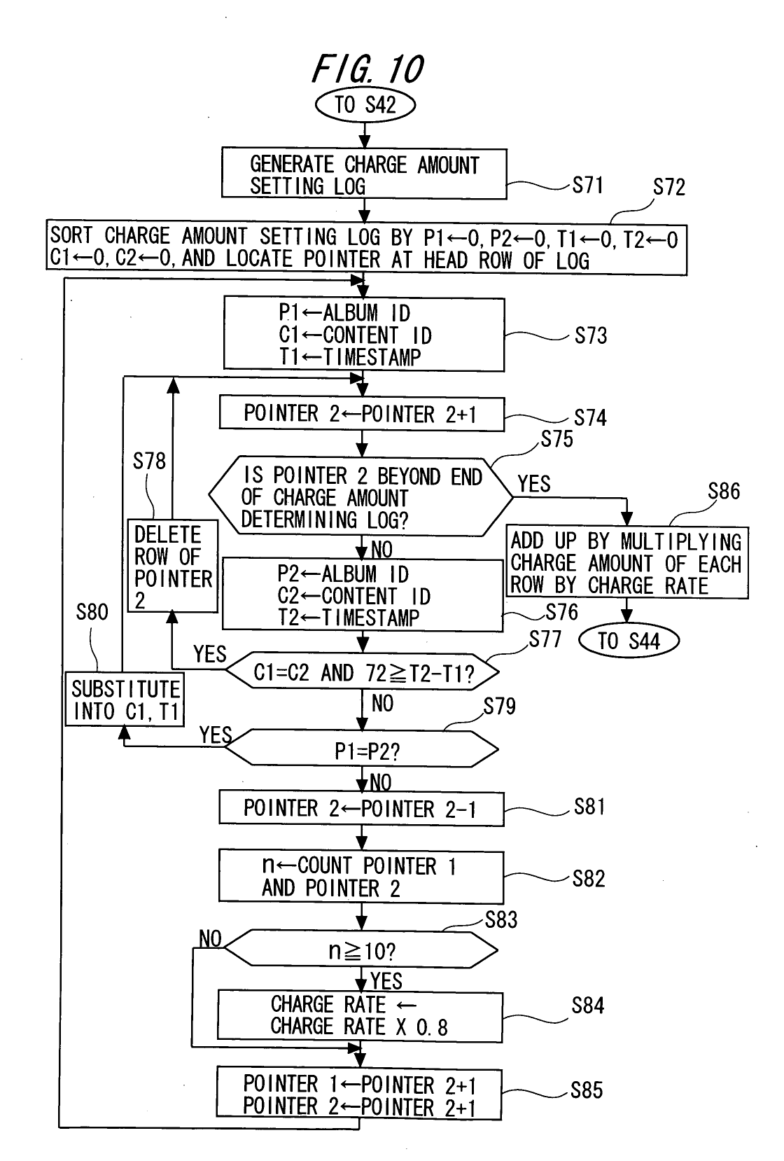

Still further, the charge amount may also be determined in combination with other discount conditions. FIG. 10 shows, in addition to the processes described above, an example of obtaining the charge amount with a discount in the case of reproducing the same content.

At first, the charge amount determining unit reads an album identifier associated with the data identifier, the charge amount and reproduction start request time (timestamp) from the attribute DB with respect to each event in the log that is extracted in S42, and adds a column of a charge rate in which column, for example “1” is assigned as an initial value, thus generating a charge amount determining log. Namely, this log is generated by adding the timestamp to the charge amount determining log shown in FIG. 9 (S71).

Further, the charge amount determining unit, by way of initial setting, sets “0” in values of variables P1, P2, C1, C2, T1, T2, and sorts the respective events in the log in the ascending sequence or the descending sequence according to the album identifier and further sorts the respective events having the same album identifier in the ascending sequence or the descending sequence according to the content identifier.

Then, the pointer 1 and the pointer 2 that point the position of the processing target event are located in the foremost row in the log (S72), the album identifier of the row pointed by the pointer 1 is substituted into the variable P1, the content ID is substituted into the variable C1, and the timestamp is substituted into the variable T1, respectively (S73).

The pointer 2 is located in the next row (S74), and it is judged whether or not this pointer 2 is beyond the last row in the log (S75). If the pointer 2 is not beyond the last row, the album identifier of the row where the pointer 2 is located is substituted into the variable P2, the content ID is substituted into the variable C2, and the timestamp is substituted into the variable T2, respectively (S76). If the variable C1 is the same as the variable C2 and if an interval between T1 and T2 is within a predetermined period of time (e.g., 72 hours) (S77), the row where the pointer 2 is located is deleted, and the processing returns to S74 (S78). In S76, if the variable C1 and the variable C2 are different from each other or if the interval between T1 and T2 are larger than the predetermined period of time, the variable P1 is compared with the variable P2 (S79), if coincident, the content ID of the row pointed by the pointer 2 is substituted into the variable C1, the timestamp is substituted into the variable T1 respectively, and the processing returns to S74 (S80). Moreover, if the variable P1 is different from the variable P2, the pointer 2 is moved back to the row one before (S81).

The charge amount determining unit counts how many rows exist from the pointer 2 to the pointer 1 (including the pointer row), i.e., counts the number of contents designated in the same album (S82). The charge amount determining unit judges whether this row count reaches a reference value for becoming a discount target (S83) and, if equal to or higher than the reference value (which is 10 in the case of the example of this time), multiplies a discount rate (which is 0.8 in the case of the example of this time) corresponding to that row count by a charge rate of each of the events from the pointer 2 to the pointer 1 (S84). After this step 84, or after judging in step 83 that the row count is less than the reference value, the pointer 1 and the pointer 2 are moved to the row next to the pointer 2, and, returning to step 73, the same processes are repeated (S85).

Then, when judging in step 75 that the pointer 2 is beyond the last row in the log, the charge amount determining unit, after multiplying the charge amount for each row by the charge rate, adds up the charge amounts for all rows (S86).

Note that the timestamp may also be a reproduction end request date without being limited to the reproduction start request date.

Further, a scheme in S78 is that even when the same content is reproduced a plurality of times, as the rows containing the same content ID are deleted, the charge amount becomes an amount charged for one reproduction, however, a low charge amount may be set corresponding to the number of reproductions. For example, on the occasion of deleting the overlapped rows in S65, 0.1 is added to the charge rate of the row that is more anterior by one than the pointer 2, or the charge rate is multiplied by 1.1. This scheme enables the charge amount to be a 10% charge amount from the second time onward in the case of reproducing the same content a plurality of times.

With this scheme, the server 1, when requested to reproduce the content designated in the album, if the already-reproduced content, i.e., the content that has been viewed or listened to by the user, this content can not be charged or can be priced low, whereby the proper charge can be conducted. Accordingly, even when the already-listened music is compiled in the album, it is possible to promote the reproduction on an album-by-album basis.

Furthermore, in the process of obtaining the charge amount, a discount condition other than this may also be added.

For example, if the time from the reproduction start request to the reproduction end request is within 10 sec in the case of music or within 5 min in the case of a movie, the charge rate is multiplied by 0 or 0.2.

Further, one or more discount target contents are determined at random (the user may be or may not be previously notified of this or these contents), and the charge rate about any one of these contents is multiplied by 0.5.

Furthermore, the number of the reproduction start requests of each of the contents is counted for a predetermined period, then ranking of the contents is determined in the sequence from the largest request count, and the charge amount of the content is multiplied by a predetermined discount rate corresponding to this ranking.

It should be noted that the content is not limited to the music and may suffice on condition that the content is electronic data usable by the communication apparatus, such as a dynamic image and a computer program. Namely, in place of reproducing (relaying) the music, the computer program may be executed, and the electronic data may also be utilized.

As described above, according to the embodiment, the charge amount for the content is determined based on the album information of the content, thereby making it possible to provide a technology enabling the proper accounting process.

Others

The invention is not limited to only the illustrated examples given above and can be, as a matter of course, changed in a variety of forms in the range that does not deviate from the gist of the invention.

Incorporation by Reference

The disclosures of Japanese patent application No. JP2005-187602 filed on Jun. 28, 2005 including the specification, drawings and abstract are incorporated herein by reference.

What is claimed is:

1. An accounting processing device comprising:
a request receiving unit receiving a content use request from a communication apparatus;
a storage unit stored with group information showing a group of contents; and
a charge amount determining unit determining charge amounts of the plurality of contents on the basis of the content group information.

2. An accounting processing device according to claim 1, further comprising a key transmission unit transmitting, when receiving the use request for the encrypted content, a decryption key for the content to the communication apparatus,
wherein when transmitting the decryption key, the charge amount determining unit determines the charge amount.

3. An accounting processing device according to claim 1, wherein if the number of the use requests for the contents belonging to the same group exceeds a predetermined number, the charge amount determining means determines a charge amount to be lower than in the case of being equal to or smaller than the predetermined number.

4. An accounting processing method by which a computer executes:
receiving a content use request from a communication apparatus;
searching out group information associated with the content from a storage unit stored with the group information showing a group of contents; and
determining charge amounts of the plurality of contents on the basis of the content group information.

5. An accounting processing method according to claim 4, wherein the computer further executes transmitting, when receiving the use request for the encrypted content, a decryption key for the content to the communication apparatus, and
when transmitting the decryption key, the charge amount determining unit determines the charge amount.

6. An accounting processing method according to claim 4, wherein if the number of the use requests for the contents belonging to the same group exceeds a predetermined number, a charge amount is determined to be lower than in the case of being equal to or smaller than the predetermined number.

7. A recording medium stored with a program making a computer executes:
receiving a content use request from a communication apparatus;
searching out group information associated with the content from a storage unit stored with the group information showing a group of contents; and
determining charge amounts of the plurality of contents on the basis of the content group information.

8. A recording medium according to claim 7, wherein the computer further executes transmitting, when receiving the use request for the encrypted content, a decryption key for the content to the communication apparatus, and
when transmitting the decryption key, the charge amount determining unit determines the charge amount.

9. A recording medium according to claim 7, wherein if the number of the use requests for the contents belonging to the same group exceeds a predetermined number, a charge amount is determined to be lower than in the case of being equal to or smaller than the predetermined number.

10. A content distribution system including a communication apparatus and a server that connected via a network, the server comprising:
a request receiving unit receiving a content use request from a communication apparatus;
a storage unit stored with group information showing a group of contents; and
a charge amount determining unit determining charge amounts of the plurality of contents on the basis of the content group information, the communication apparatus comprising:
a use request unit transmitting a request for using a content to be reproduced to the server; and
a reproducing unit reproducing the content.

11. A content distribution system according to claim 10, wherein the server comprises a key transmission unit transmitting, when receiving the use request for the encrypted content, a decryption key for the content to the communication apparatus,
wherein when transmitting the decryption key, the charge amount determining unit determines the charge amount.

12. A content distribution system according to claim 11, wherein the communication apparatus comprises a decrypting unit decrypting the content when the communication apparatus receives the decryption key.

13. A content distribution system according to claim 12, wherein the content is segmented into a plurality of continuous files, and the files are respectively encrypted, and
during a period from a point of time when the reproducing unit of the communication apparatus starts reproducing the file structuring the content to a point of time when finishing reproducing the file, the use request unit makes a request for using a next file, and, upon receiving the decryption key matching with the use request, the decryption unit decrypts the next file.

14. A content distribution system according to claim 10, wherein if the number of the use requests for the contents belonging to the same group exceeds a predetermined number, the charge amount determining unit determines a charge amount to be lower than in the case of being equal to or smaller than the predetermined number.
